(19) United States
(12) Patent Application Publication
(10) Pub. No.: US 2020/0258001 A1
(43) Pub. Date: Aug. 13, 2020

(54) DYNAMICALLY DETERMINING A USER'S AVAILABILITY FOR AN ACTIVITY

(71) Applicant: LENOVO (Singapore) PTE. LTD., New Tech Park (SG)

(72) Inventors: Nathan J Peterson, Oxford, NC (US); Mark Patrick Delaney, Raleigh, NC (US); John Carl Mese, Cary, NC (US); Russell Speight VanBlon, Raleigh, NC (US)

(21) Appl. No.: 16/269,799

(22) Filed: Feb. 7, 2019

(51) Int. Cl. G06N 20/00; H04L 29/08

(52) U.S. Cl. CPC G06N 20/00; H04L 67/22

(57) ABSTRACT

Apparatuses, methods, systems, and program products are disclosed for dynamically determining a user's availability for an activity. An apparatus includes a processor and a memory that stores code executable by the processor. The memory stores code executable by the processor to determine a context for a user. The context includes one or more characteristics that define the user's current activity state. The memory stores code executable by the processor to check predefined context criteria against the user's context to determine the user's availability status for one or more activities. The memory stores code executable by the processor to make the availability status accessible to one or more interested devices.

### FIELD

The subject matter disclosed herein relates to determining a user's availability, and more particularly relates to dynamically determining a user's availability for an activity based on the user's context.

### BACKGROUND

Various factors may determine whether a user is available for a specific activity. It can be frustrating going back and forth with a user to determine whether the user is available for an activity or will be available for the activity. The frustration is exacerbated when trying to coordinate an activity among a plurality of users.

### BRIEF SUMMARY

An apparatus for dynamically determining a user's availability for an activity is disclosed. The apparatus, in one embodiment, includes a processor and a memory that stores code executable by the processor. In certain embodiments, the memory stores code executable by the processor to determine a context for a user. The context may include one or more characteristics that define the user's current activity state. In some embodiments, the memory stores code executable by the processor to check predefined context criteria against the user's context to determine the user's availability status for one or more activities. In various embodiments, the memory stores code executable by the processor to make the availability status accessible to one or more interested devices.

A method for dynamically determining a user's availability for an activity includes, in one embodiment, determining, by a processor, a context for a user. The context may include one or more characteristics that define the user's current activity state. The method, in some embodiments, includes checking predefined context criteria against the user's context to determine the user's availability status for one or more activities. The method, in various embodiments, includes making the availability status accessible to one or more interested devices.

A program product for dynamically determining a user's availability for an activity, in one embodiment, includes a computer readable storage medium that stores code executable by a processor. In some embodiments, the executable code includes code to perform determining a context for a user. The context may include one or more characteristics that define the user's current activity state. The executable code, in certain embodiments, includes code to perform checking predefined context criteria against the user's context to determine the user's availability status for one or more activities. The executable code, in certain embodiments, includes code to perform making the availability status accessible to one or more interested devices.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for dynamically determining a user's availability for an activity;

FIG. 2 is a schematic block diagram illustrating one embodiment of an apparatus for dynamically determining a user's availability for an activity;

FIG. 3 is a schematic block diagram illustrating one embodiment of another apparatus for dynamically determining a user's availability for an activity;

FIG. 4 is a schematic flow chart diagram illustrating one embodiment of a method for dynamically determining a user's availability for an activity; and

FIG. 5 is a schematic flow chart diagram illustrating one embodiment of another method for dynamically determining a user's availability for an activity.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus for dynamically determining a user's availability for an activity is disclosed. The apparatus, in one embodiment, includes a processor and a memory that stores code executable by the processor. In certain embodiments, the memory stores code executable by the processor to determine a context for a user. The context may include one or more characteristics that define the user's current activity state. In some embodiments, the memory stores code executable by the processor to check predefined context criteria against the user's context to determine the user's availability status for one or more activities. In various embodiments, the memory stores code executable by the processor to make the availability status accessible to one or more interested devices.

In one embodiment, the availability status is automatically provided to the one or more interested devices in response to the availability status indicating that the user is available for the one or more activities. In certain embodiments, the availability status is provided to the one or more interested devices in response to receiving an availability status request for the one or more activities from the one or more interested devices.

In one embodiment, in response to the availability status request being associated with an activity that does not have corresponding context criteria, the code is further executable by the processor to prompt the user to define context criteria for the activity. In further embodiments, the code is further executable by the processor to provide one or more context criteria recommendations for the activity.

In one embodiment, the code is further executable by the processor to generate the one or more context criteria recommendations using machine learning. The machine learning may analyze historical and current context criteria settings for one or more activities to generate the one or more context criteria recommendations. In certain embodiments, the code is further executable by the processor to further provide one or more activities that the user is available for in response to the availability status request.

In one embodiment, the code is further executable by the processor to periodically monitor and update the user's context, check the predefined context criteria against the user's updated context, and revise the user's availability status for the one or more activities based on the user's updated context. In some embodiments, the code is further executable by the processor to estimate an amount of time until the user is available for the activity in response to the availability status indicating that the user is not available for an activity or estimate an amount of time until the user is no longer available for the activity in response to the availability status indicating that the user is available for an activity.

In one embodiment, the code is further executable by the processor to automatically define context criteria for an activity based on one or more previously defined context criteria settings for activities that have similar characteristics to the activity. In various embodiments, the availability status is made accessible via an electronic communication, which may include one or more of a text message, a push notification, an email, a voicemail, and an instant message.

In one embodiment, the predefined context criteria comprise one or more settings associated with one or more activities and a context. In further embodiments, the characteristics that define the user's context comprise one or more of the user's location, a calendar event for the user, a time of day, biometric information for the user, people within a proximity of the user, and network connectivity for the user's device.

A method for dynamically determining a user's availability for an activity includes, in one embodiment, determining, by a processor, a context for a user. The context may include one or more characteristics that define the user's current activity state. The method, in some embodiments, includes checking predefined context criteria against the user's context to determine the user's availability status for one or more activities. The method, in various embodiments, includes making the availability status accessible to one or more interested devices.

In one embodiment, the availability status is automatically provided to the one or more interested devices in response to the availability status indicating that the user is available for the one or more activities. In certain embodiments, the availability status is provided to the one or more interested devices in response to receiving an availability status request for the one or more activities from the one or more interested devices.

In one embodiment, the method includes prompting the user to define context criteria for the activity in response to the availability status request being associated with an activity that does not have corresponding context criteria. In certain embodiments, the method includes generating one or more context criteria recommendations for the activity using machine learning. The machine learning includes analyzing historical and current context criteria settings for one or more activities to generate the one or more context criteria recommendations.

In one embodiment, the method includes periodically monitoring and updating the user's context, checking the predefined context criteria against the user's updated context, and revising the user's availability status for the one or more activities based on the user's updated context.

A program product for dynamically determining a user's availability for an activity, in one embodiment, includes a computer readable storage medium that stores code executable by a processor. In some embodiments, the executable code includes code to perform determining a context for a user. The context may include one or more characteristics that define the user's current activity state. The executable code, in certain embodiments, includes code to perform checking predefined context criteria against the user's context to determine the user's availability status for one or more activities. The executable code, in certain embodiments, includes code to perform making the availability status accessible to one or more interested devices.

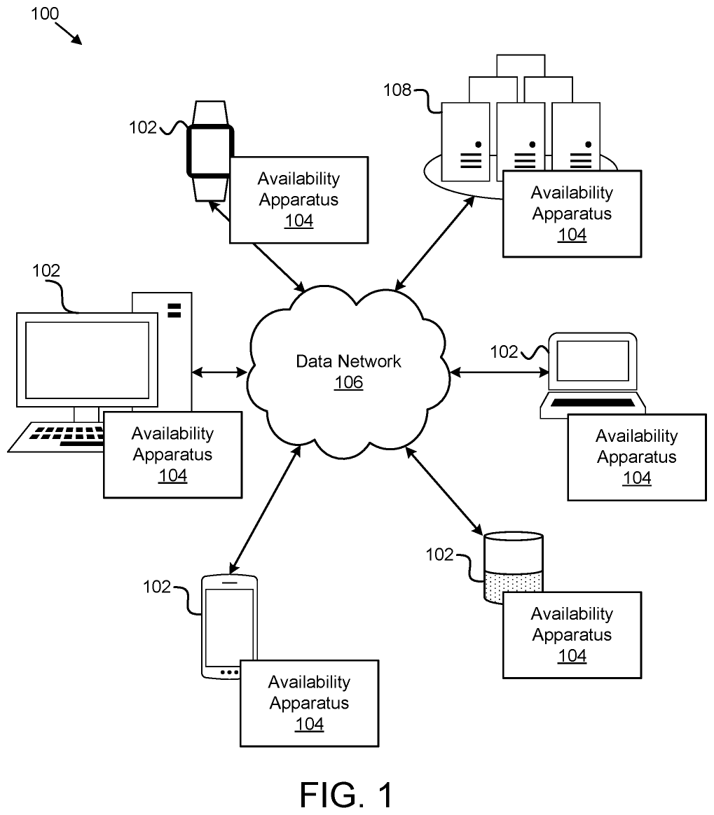

FIG. 1 is a schematic block diagram illustrating one embodiment of a system 100 for dynamically determining a user's availability for an activity. In one embodiment, the system 100 includes one or more information handling devices 102, one or more availability apparatuses 104, one or more data networks 106, and one or more servers 108. In certain embodiments, even though a specific number of information handling devices 102, availability apparatuses 104, data networks 106, and servers 108 are depicted in FIG. 1, one of skill in the art will recognize, in light of this disclosure, that any number of information handling devices 102, availability apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like. The information handling devices 102 may include various sensors for sensing, collecting, monitoring, or the like environmental data. The sensors may include location sensors (e.g., global positioning system (“GPS”) sensors), proximity sensors, wireless signal sensors (e.g., sensors configured to sense wireless signals emitted from other devices such as Bluetooth® signals, Wi-Fi signals, near field communication (“NFC”) signals, and/or the like), accelerometers, gyroscopes, light sensors, sound sensors, biometric sensors (e.g., blood pressure sensors, heart-rate monitors, fingerprint sensors, oxygen sensors, and/or the like), and/or the like.

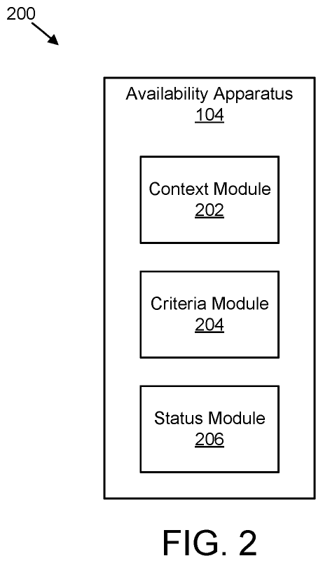

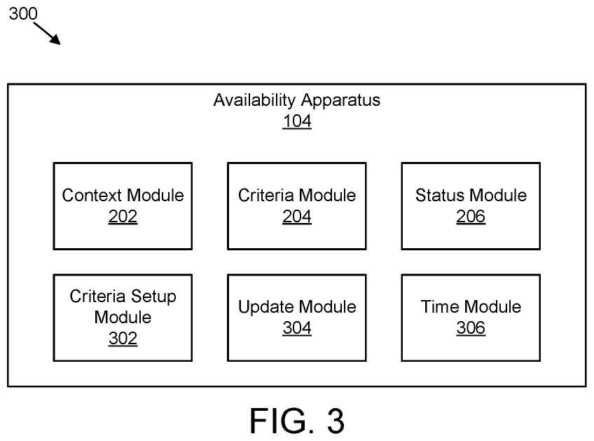

In one embodiment, the availability apparatus 104 is configured to dynamically determine whether a user is available for an activity based on predefined criteria and provide the user's availability to other devices. The availability apparatus 104, in one embodiment, determines a context for a user, which includes one or more characteristics that define the user's current activity state; checks predefined context criteria against the user's context to determine the user's availability status for one or more activities; and makes the availability status accessible to one or more interested devices. The availability apparatus 104, including its various sub-modules, may be located on one or more information handling devices 102 in the system 100, one or more servers 108, one or more network devices, and/or the like. The availability apparatus 104 is described in more detail below with reference to FIGS. 2 and 3.

In one embodiment, the availability apparatus 104 improves upon conventional systems for providing the user's availability by automatically determining the user's context, e.g., the user's activity state and comparing the context to predefined availability criteria to determine whether the user is available to perform an activity, task, or the like. For example, the availability apparatus 104 may receive a request from the user's friend's device to check if the user is available to play tennis. The availability apparatus 104 may check the user's context based on sensor data that the user's device's sensors collect and compare that with predefined context criteria that the user has established to indicate whether the user is available based on the context. The user may have defined criteria for a tennis activity that indicates the user is available for tennis if it is between 6 PM and 9 PM on a weekday and the user is not with other family members (e.g., not eating dinner with his family), and if the user is not at the office (as determined based on information sensed/collected using the sensors on the user's device). If the user's context matches the predefined criteria, then the availability apparatus 104 may determine that the user is available for tennis and will notify the user's friend's device that the user is available to play tennis.

In various embodiments, the availability apparatus 104 may be embodied as a hardware appliance that can be installed or deployed on an information handling device 102, on a server 108, or elsewhere on the data network 106. In certain embodiments, the availability apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the availability apparatus 104 may include a power interface, a wired and/or wireless network interface, a graphical interface that attaches to a display, and/or a semiconductor integrated circuit device as described below, configured to perform the functions described herein with regard to the availability apparatus 104.

The availability apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the availability apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the availability apparatus 104.

The semiconductor integrated circuit device or other hardware appliance of the availability apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the availability apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. For instance, a server 108 may be an intermediary between information handling devices 102 to facilitate sending and receiving electronic messages between the information handling devices 102. The servers 108 may further comprise third-party servers 108 such as weather servers, traffic servers, location servers, and/or the like, which the availability apparatus 104 may access, query, search, or the like to determine a user's current context.

FIG. 2 is a schematic block diagram illustrating one embodiment of an apparatus 200 for dynamically determining a user's availability for an activity. In one embodiment, the apparatus 200 includes an embodiment of an availability apparatus 104. The availability apparatus 104, in some embodiments, includes one or more of a context module 202, a criteria module 204, and a status module 206, which are described in more detail below.

The context module 202, in one embodiment, is configured to determine a context for a user. The context, as used herein, may include one or more characteristics that define the user's current activity state. For instance, the user's context may include the user's location, a calendar event, the time of day, biometric information for the user, people within a proximity of the user, network connectivity for the user's device, and/or the like. The context module 202 may determine the user's current context, may track the user's historical context, and/or may estimate, forecast, or predict the user's future context (e.g., based on the historical context, using machine learning, and/or the like).

For example, the context module 202 may store sensor data associated with the user's context at predetermined intervals (e.g., in real-time, every five minutes, every half-hour, every hour, or the like), and may use the historical context data to forecast the user's future context using machine learning or other artificial intelligence algorithms, as one of skill in the art would recognize in light of this disclosure.

In one embodiment, the context module 202 may store the context information for a user in a data structure that is accessible to other modules, functions, or the like. The data structure may have a predefined format for storing the various different data elements that define the user's context. For instance, the data structure may be an indexable <key, value> table such that the values in the table can be accessed using a key, e.g., the value for the user's location may be determined by using the key “location” to lookup the value for the location. A null value may be used to represent no data for a particular key.

The criteria module 204, in one embodiment, is configured to check predefined context criteria against the user's context to determine the user's availability status for one or more activities. In one embodiment, the predefined context criteria include various settings, preferences, or the like that are associated with an activity and a user context. For instance, the context criteria may be set on a per-activity basis. For example, the user may specify that he is available for tennis by setting criteria such as the time has to be between 6 PM and 9 PM Monday through Friday, the user cannot be with other members of his family, the user cannot be at the office, and the user cannot have already exercised at some point during the day.

The user can define various criteria for determining the user's availability for different activities such as the user's location, the location of the activity, the length of the activity, the time of the activity, the distance to the activity, the people participating in the activity, people who are with the user, whether the user is sleeping/eating/working, a type of calendar event (e.g., meeting, lunch, etc.), the strength or type of network connectivity, a mobile application that the user is using, and/or the like.

For example, the user may setup context criteria that specifies when the user is available for a work call. The user's only criteria may be that the user is not with his family. In another example, the user may setup context criteria that specifies when the user is available to play on his PlayStation® with his brother. The context criteria may include (1) the user is at home, (2) between the hours of 8 PM and 10 PM, and (3) not eating dinner or watching television with his family. In yet another example, the user may setup context criteria that specifies when the user is available for a face-to-face meeting. The context criteria may include (1) the user is at the office, (2) the user is not currently in another meeting, and (3) the user is within a certain distance of the meeting requestor (based on locations of the user's and the requestor's devices). In a further example, the user may setup context criteria that specifies when the user is available to Facetime® (e.g., to hold a video call). The context criteria may include (1) the user is not in a meeting, (2) the user is not eating or watching television with his family, and (3) the user's device is connected to Wi-Fi. One of skill in the art will recognize the myriad different context criteria that can be established for different activities in light of this disclosure.

In certain embodiments, the criteria module 204 determines the user's availability by comparing the context information that the user's device's sensors capture and store to the context criteria for a particular activity. For instance, in response to receiving a text message asking the user if the user is available for lunch at noon, the criteria module 204 may check the user's current context against context criteria that the user has established for the “lunch” activity (e.g., user located at the office, lunch time at noon, no meetings scheduled from noon to 1 PM, etc.). If the user's current context satisfies the context criteria for the “lunch” activity, the availability status for the user is set to available (e.g., a flag, bit, byte, variable, or the like is set to a value (e.g., 1 or 0) that indicates the user is available).

In some embodiments, the status module 206, is configured to make the availability status accessible to one or more interested devices. The interested devices, as used herein, may be other user's devices that are used to query the user's device to see if the user is available. An interested device may also include the user's device so that the user's availability status may be indicated to other users, e.g., as a graphical indication from the user's device.

In one embodiment, for instance, the status module 206 makes the availability status accessible to applications that execute on the user's device. In this manner, the applications can provide an indication of the user's availability to other users. For example, a Facebook® application can provide a real-time, accurate indication of the user's availability to chat, play a game, watch a video, or the like. Similarly, a texting application can provide an indication of the user's availability to respond to a text message. Furthermore, the status module 206 may send an electronic communication to one or more devices of other users who may be interested in the user's availability.

In some embodiments, the status module 206 provides the availability status to the one or more interested devices in response to the availability status indicating that the user is available for one or more activities. For example, if the status module 206 determines that the user typically goes out with his friends on Wednesday nights, the status module 206 may send a notification to the user's friends indicating that the user is available to go out if the user's context satisfies the context criteria for going out on Wednesday night.

In various embodiments, the status module 206 provides the availability status to the one or more interested devices in response to receiving an availability status request for the one or more activities from the one or more interested devices. For example, a user's friend may send a text message to the user to see if the user is available to play a video game together on the Xbox®. In response to the request, the criteria module 204 may check the user's context against the context criteria for the activity “Xbox” to determine whether the user is available to play Xbox®. The status module 206 may then send the determined availability status to the requesting user.

In certain embodiments, when an electronic communication is received at the user's device, the status module 206 may parse the electronic communication and use natural language processing to determine whether the electronic communication includes a request for the user to perform a task or participate in an activity. If so, then the availability apparatus 104 dynamically determines whether the user is available based on the user's context and the context criteria associated with the task/activity and provides the availability to the requestor. In this manner, the user does not need to respond to the text message and the requesting user does not have to wait for a response—the availability apparatus 104 can automatically respond with the user's availability status without the user's input or interaction.

In one embodiment, the request may be a request be notified when the user is available for a specific activity. For instance, the request may include a request to be notified when the user is available for to play a multi-player video game, to play tennis, to have a phone call, to schedule a meeting, or the like. The status module 206 may store and track the requests and send the availability status when the user is available for one or more activities or tasks specified in the request.

In further embodiments, the status module 206 provides a list of one or more activities that the user is available for in response to an availability status request. For example, if the user is not available for tennis, the criteria module 204 may compare the user's context to the context criteria for a plurality of activities to determine activities, if any, that the user is available to participate in, and the status module 206 may then send the determined activities to the requesting user. In such an embodiment, the criteria module 204 further determines the identity of the requesting user and a history of the activities that the user and the requesting user have participated in together to determine the list of activities that the user is available for.

In some embodiments, the status module 206 proactively notifies other devices/users when the user become available for an activity that the user and the other user(s) typically participate in. For example, if the user and his friend Bill typically have lunch every Wednesday around noon, the status module 206 may trigger the criteria module 204 to determine the user's availability for “lunch with Bill” may send Bill a text message indicating that the user is available for lunch if, in fact, the criteria module 204 determines that the user is available for lunch based on the user's context.

FIG. 3 is a schematic block diagram illustrating one embodiment of an apparatus 300 for dynamically determining a user's availability for an activity. In one embodiment, the apparatus 300 includes an embodiment of an availability apparatus 104. The availability apparatus 104, in some embodiments, includes one or more of a context module 202, a criteria module 204, and a status module 206, which may be substantially similar to the context module 202, the criteria module 204, and the status module 206 described above with reference to FIG. 2. In further embodiments, the availability apparatus 104 includes one or more of a criteria setup module 302, an update module 304, and a time module 306, which are described in more detail below.

In one embodiment, the criteria setup module 302 is configured to prompt the user to define context criteria for an activity. The criteria setup module 302, for example, may present a graphical interface that the user can interact with to specify an activity and define the context criteria for the activity that indicates the circumstances under which the user is available to perform the activity. The criteria setup module 302 may provide a predefined list of activities and/or allow the user to create custom activities.

In one embodiment, the criteria setup module 302 prompts the user to define context criteria for an activity associated with an availability status request in response to the activity not having corresponding context criteria. In other words, if the availability status request is for an activity that does not have context criteria defined by the user, the criteria setup module 302 proceeds to prompt the user to define context criteria for the activity.

In certain embodiments, the criteria setup module 302 generates and provides context criteria recommendations for an activity. For instance, the criteria setup module 302 may use machine learning and/or artificial intelligence algorithms to predict, forecast, estimate, or the like recommendations or suggestions for defining context criteria for an activity. For instance, if the user receives a request to play golf, but the user has yet to define criteria defining when the user is available for golf, the criteria setup module 302 may utilize machine learning to identify different contexts where the user would be available for golf based on an analysis of the game of golf (e.g., how long it takes to play, where it can be played relative to the user, the times of day/year when it can be played, and so on, which may be determined by querying an online dictionary/encyclopedia about golf) and on context criteria that are defined for similar activities/sports such as tennis, basketball, volleyball, or the like.

In one embodiment, the update module 304 is configured to periodically update the user's context, e.g., every five minutes, every half hour, every hour, and so on. The update module 304 may check the predefined context criteria against the user's updated context and revise the user's availability status for one or more activities based on the user's updated context. For example, the data structure for the context criteria may include a field for each activity that has a flag, bit, or other value that indicates whether the user is available for the activity or not, and the update module 304 may update the availability field periodically, e.g., when the user's context is updated. In this manner, the user's availability status is continuously updated to account for the user's changing context throughout the day.

The time module 306, in one embodiment, is configured to estimate an amount of time until the user is available for an activity based on the user's context. For instance, if the user is in a meeting, and the meeting is set on the user's calendar to last another half hour, the time module 306 may estimate that the user will be available in a half hour. The status module 206 may further provide this information to interested devices to let other users know that the user may not currently be available for an activity but may be available in about a half hour.

Similarly, in further embodiments, the time module 306 is configured to estimate an amount of time that until the user is no longer available for the activity. For instance, if the user is currently available for lunch, but has a meeting scheduled in an hour, then the time module 306 may estimate that the user has less than an hour for lunch. The status module 206 may further provide this information to interested devices to let other users know that the user is currently available for an activity for the estimated amount of time.

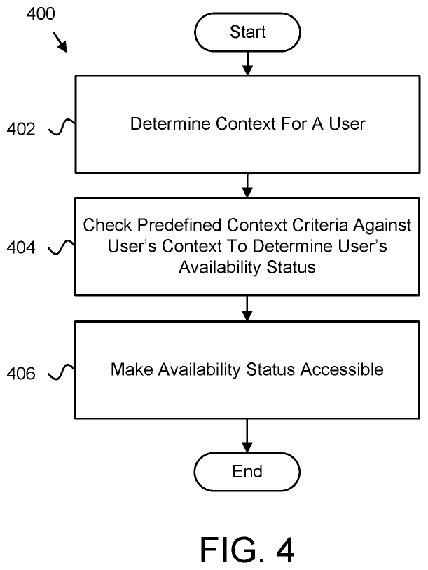

FIG. 4 is a schematic flow chart diagram illustrating one embodiment of a method 400 for dynamically determining a user's availability for an activity. In one embodiment, the method 400 begins and determines 402 the user's context. The method 400, in certain embodiments, checks 404 predefined context criteria against the user's context to determine the user's availability status for one or more activities. In some embodiments, the method 400 makes 406 the availability status accessible to one or more interested devices, and the method 400 ends. In various embodiments, the context module 202, the criteria module 204, and the status module 206 perform the various steps of the method 400.

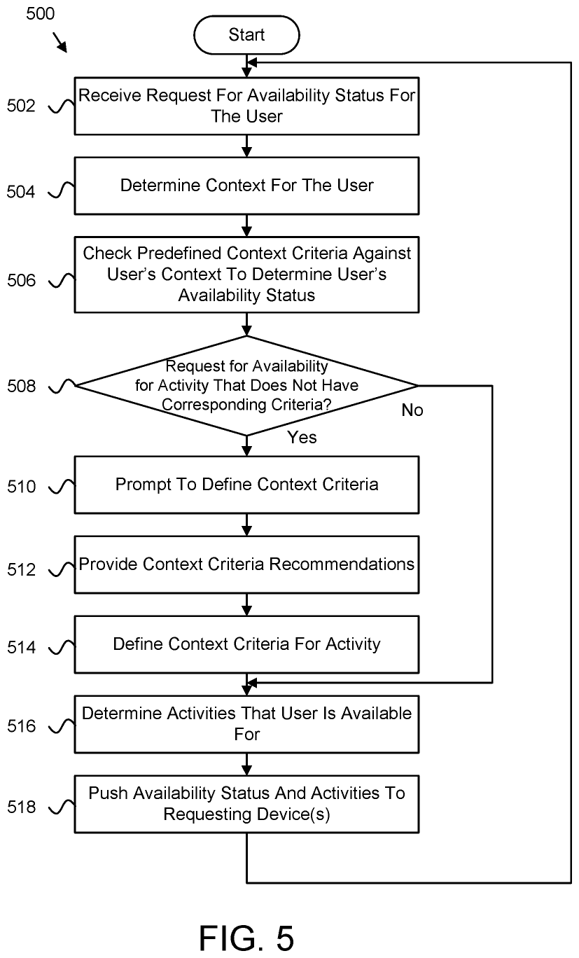

FIG. 5 is a schematic flow chart diagram illustrating one embodiment of another method 500 for dynamically determining a user's availability for an activity. In one embodiment, the method 500 begins and receives 502 a request for an availability status for the user for an activity/task. The method 500, in certain embodiments, determines 504 the user's context.

In further embodiments, the method 500 checks 506 predefined context criteria against the user's context to determine the user's availability status for one or more activities. The method 500, in various embodiments, determines 508 whether the request for the availability status is for an activity that does not have corresponding context criteria defined. If so, the method 500, in one embodiment, prompts 510 the user to define context criteria for the activity. The method 500 may provide 512 recommendations or suggestions for defining the context criteria for the activity.

In one embodiments, the method 500 defines 514 the context criteria for the activity based on the user input and/or the recommendations/suggestions and determines 516 one or more activities that the user is available for, in addition to or in place of the activity that is part of the request. The method 500, in further embodiments, pushes 518 the availability status for the user and the one or more activities that the user is available for to the requesting device(s), and the method 500 ends. In various embodiments, the context module 202, the criteria module 204, the status module 206, and the criteria setup module 302 perform the various steps of the method 500.

Embodiments may be practiced in other specific forms. The described embodiments are to be considered in all respects only as illustrative and not restrictive. The scope of the subject matter disclosed herein is, therefore, indicated by the appended claims rather than by the foregoing description. All changes which come within the meaning and range of equivalency of the claims are to be embraced within their scope.

What is claimed is:

1. An apparatus comprising:
a processor; and
a memory that stores code executable by the processor to:
determine a context for a user, the context comprising one or more characteristics that define the user's current activity state;
check predefined context criteria against the user's context to determine the user's availability status for one or more activities; and
make the availability status accessible to one or more interested devices.

2. The apparatus of claim 1, wherein the availability status is automatically provided to the one or more interested devices in response to the availability status indicating that the user is available for the one or more activities.

3. The apparatus of claim 1, wherein the availability status is provided to the one or more interested devices in response to receiving an availability status request for the one or more activities from the one or more interested devices.

4. The apparatus of claim 3, wherein, in response to the availability status request being associated with an activity that does not have corresponding context criteria, the code is further executable by the processor to prompt the user to define context criteria for the activity.

5. The apparatus of claim 4, wherein the code is further executable by the processor to provide one or more context criteria recommendations for the activity.

6. The apparatus of claim 5, wherein the code is further executable by the processor to generate the one or more context criteria recommendations using machine learning, the machine learning analyzing historical and current context criteria settings for one or more activities to generate the one or more context criteria recommendations.

7. The apparatus of claim 3, wherein the code is further executable by the processor to further provide one or more activities that the user is available for in response to the availability status request.

8. The apparatus of claim 1, wherein the code is further executable by the processor to:
periodically monitor and update the user's context;
check the predefined context criteria against the user's updated context; and
revise the user's availability status for the one or more activities based on the user's updated context.

9. The apparatus of claim 1, wherein the code is further executable by the processor to:
in response to the availability status indicating that the user is not available for an activity, estimate an amount of time until the user is available for the activity; and
in response to the availability status indicating that the user is available for an activity, estimate an amount of time until the user is no longer available for the activity.

10. The apparatus of claim 1, wherein the code is further executable by the processor to automatically define context criteria for an activity based on one or more previously defined context criteria settings for activities that have similar characteristics to the activity.

11. The apparatus of claim 1, wherein the availability status is made accessible via an electronic communication, the electronic communication comprising one or more of a text message, a push notification, an email, a voicemail, and an instant message.

12. The apparatus of claim 1, wherein the predefined context criteria comprise one or more settings associated with one or more activities and a context.

13. The apparatus of claim 1, wherein the characteristics that define the user's context comprise one or more of the user's location, a calendar event for the user, a time of day, biometric information for the user, people within a proximity of the user, and network connectivity for the user's device.

14. A method comprising:
determining, by a processor, a context for a user, the context comprising one or more characteristics that define the user's current activity state;
checking predefined context criteria against the user's context to determine the user's availability status for one or more activities; and
making the availability status accessible to one or more interested devices.

15. The method of claim 14, wherein the availability status is automatically provided to the one or more interested devices in response to the availability status indicating that the user is available for the one or more activities.

16. The method of claim 14, wherein the availability status is provided to the one or more interested devices in response to receiving an availability status request for the one or more activities from the one or more interested devices.

17. The method of claim 16, further comprising prompting the user to define context criteria for the activity in response to the availability status request being associated with an activity that does not have corresponding context criteria.

18. The method of claim 17, further comprising generating one or more context criteria recommendations for the activity using machine learning, the machine learning analyzing historical and current context criteria settings for one or more activities to generate the one or more context criteria recommendations.

19. The method of claim 13, further comprising:
periodically monitoring and updating the user's context;
checking the predefined context criteria against the user's updated context; and
revising the user's availability status for the one or more activities based on the user's updated context.

20. A program product comprising a computer readable storage medium that stores code executable by a processor, the executable code comprising code to perform:
determining a context for a user, the context comprising one or more characteristics that define the user's current activity state;
checking predefined context criteria against the user's context to determine the user's availability status for one or more activities; and
making the availability status accessible to one or more interested devices.
